(19) United States
(12) Patent Application Publication
(10) Pub. No.: US 2013/0234926 A1
(43) Pub. Date: Sep. 12, 2013

(54) VISUALLY GUIDING MOTION TO BE PERFORMED BY A USER

(71) Applicant: Peter Hans Rauber, Vienna (AT)

(72) Inventor: Peter Hans Rauber, Vienna (AT)

(73) Assignee: QUALCOMM INCORPORATED, San Diego, CA (US)

(21) Appl. No.: 13/448,230

(22) Filed: Apr. 16, 2012

Related U.S. Application Data
(60) Provisional application No. 61/607,817, filed on Mar. 7, 2012.

(51) Int. Cl. G06F 3/01

(52) U.S. Cl. 345/156

(57) ABSTRACT

Motion to be performed on a device by a user is visually guided, by displaying at least one icon on a screen of the device. The icon when displayed initially has an attribute whose value is indicative of a predetermined movement to be performed on the device. The user responds to the icon's display by moving the device in the real world in an attempt to perform the predetermined movement, in whole or in part. The displayed icon is then re-displayed with a revised value of the attribute to indicate an instantaneous to-be-performed movement. The instantaneous to-be-performed movement depends on the predetermined movement and a measurement of actual movement of the handheld device, after the initial display. The re-display of the icon is performed repeatedly, to change the display of the icon's attribute based on at least the predetermined movement and additional measurements of additional movements of the handheld device.

### CROSS-REFERENCE TO PROVISIONAL APPLICATION

This application claims priority under 35 USC §119 (e) from U.S. Provisional Application No. 61/607,817 filed on Mar. 7, 2012 and entitled “VISUALLY GUIDING MOTION TO BE PERFORMED BY A USER”, which is assigned to the assignee hereof and which is incorporated herein by reference in its entirety.

### FIELD

This patent application relates to apparatuses and methods to guide a user to move a handheld device through a prescribed motion that is indicated visually, on a screen of the handheld device.

### BACKGROUND

A handheld device 101 (FIG. 1A) may be used to play a game of the prior art, wherein a user tilts device 101 (e.g. as shown in FIG. 1B) slightly from a horizontal position (relative to ground), in order to move a ball 111 under the force of gravity into a predetermined hole 112, while preventing ball 111 from falling into one or more other holes such as hole 113 during the movement of ball 111. In such a prior art game, device 101 typically uses a tilt sensor (such as an accelerometer and/or a magnetic compass) included therein to automatically sense an instantaneous orientation of device 101 relative to ground, and the orientation is then used to update the position of ball 111 on screen 102 in real time, as the user tilts device 101.

In the prior art game illustrated in FIGS. 1A-1B, a user may tilt device 101 in any desired direction, resulting in screen 102 being updated to show a corresponding movement of ball 111 due to gravity, until ball 111 eventually falls into hole 112. As the user is free to move device 101 in any manner, playing of such a game does not require the user to make any specific movement that is predetermined for use in calibration, for example to calibrate a sensor of device 101 as described below.

Conventional calibration applications may require a user to place a handheld device 101 (FIG. 1C) in a sequence of positions. One example of a predetermined sequence of positions is to first place a left edge 101L of device 100 on a horizontal surface 110 (FIG. 1D), while orienting device 101 vertically (e.g. so that screen 102 of device 101 is parallel to the Z axis), until a beep is emitted by a speaker in device 101. In the example shown in FIG. 1C, an arrow 103 initially appears on screen 102, as shown in FIG. 1C, to identify to the user that it is the left edge 101L that needs to be placed on surface 110. Arrow 103 is initially centered at the left edge 101L of screen 102. Arrow 103 remains stationary at this position on screen 102, until after a first measurement is made with left edge 101L on surface 110, as indicted by the audible beep. No video from a camera appears to be displayed during this process. Note further that the just-described user-directions, as to what to do when arrow 103 appears (e.g. place edge 101L on a flat surface), is provided to the user separately.

In this example, a next position in the sequence is indicated by displaying arrow 103 centered at a right edge 101R of device 101 (FIG. 1E), which happens as soon as the first measurement is completed. The user places right edge 101R on surface 110 (FIG. 1F), until another beep is emitted by device 101. The just-described process is repeated for bottom edge 101B (FIG. 1C), followed by top edge 101T. The next position of device 101 is flat on surface 110 with screen 102 up (facing the positive Z direction), followed by flat again with screen 102 down (facing the negative Z direction). For more information on the example shown in FIGS. 1C-1F, see the directions for calibration of software called “I'll Drive It—The Driving Instructor App” for the iPhone (available in iTunes Store, operated by Apple Inc.). For additional details on this example, please see an article entitled “I′ll Drive It—Help Information for The Driving Instructor App.” available on the Internet at the URL “www.illdriveit.com/help-information.htm”.

A sequence of positions of the type described above appears to be unsuitable for calibrations that require movement of device 101. One example of a sequence of movements is for device 101 to be moved in the shape “co” in space. Such a movement is described in written text 105 displayed on screen 102 (FIG. 1G) as follows: “re-calibrate by waving in a figure 8 motion.” One issue with such text 105 is that an uninitiated user may not understand that while the calibration movement resembles the English-language character “8” representing the number eight, the calibration movement is to be made horizontally (i.e. make the figure “∞”), rather than vertically (which is the normal orientation of the English-language character “8”).

Similarly, other written text for calibration of device 101 may be misunderstood by an uninitiated user simply tilting device 101 in different directions, although translation motions (i.e. movements of the entirety of device 101) were intended by the author of the written text. Hence, written text is not easy to follow, when a calibration movement is unknown to the user, resulting in undesirable actions and thus unsatisfactory performance of calibration algorithms and applications.

There appears to be no prior art on how, instead of written text 105 as shown in FIG. 1G, an arrow of the type shown in FIGS. 1C-1F is to be used to instruct a user to move device 101 through a predetermined movement (e.g. for calibration), rather than to position device 101 on surface 110 as described above. Hence, there is a need to guide a user to perform a motion (instead of keeping in a position), as described below.

### SUMMARY

In several aspects of embodiments described below, motion to be performed on a device by a user is visually guided by displaying at least one icon on a screen of the device. The icon when displayed initially has an attribute (such as its position on the screen, or its length on the screen) whose value is indicative of a predetermined movement that is to be performed (also called “prescribed movement”).

When such a device is moved in the real world, e.g. in an attempt by a user to perform the predetermined movement in whole or in part, the initially displayed icon is re-displayed on the screen now with a revised value of the attribute to indicate an instantaneous to-be-performed movement. The instantaneous to-be-performed movement depends on the predetermined movement and at least one measurement of actual movement of the device after the initial display of the icon on the screen. Depending on the embodiment, the measurement may be made automatically by a sensor in the device that normally measures movement of the device, e.g. a gyroscope that is built in.

The above-described re-display of the icon is performed repeatedly in a loop, using values of the attribute that are repeatedly computed. Specifically, as the device is moved in the real world, the just-described loop results in the icon's attribute's value changing on the screen, based on at least the predetermined movement and one or more additional measurements of additional movements of the device. Each time the icon is re-displayed, the icon's attribute's value is shown to indicate an instantaneous to-be-performed movement which the user is to now perform, thus repeatedly guiding the user. In some embodiments, iterations of the loop are performed several times a second, thereby to provide to the user, an appearance of continually guiding the user in response to actual movement of the device by the user.

Thus, an icon whose attribute value changes on the screen based on a prescribed movement that is to be performed and on actual movement of the device, provides visually guidance to a user in performing (and eventually completing) the prescribed movement. Moreover, a user may be visually guided in the above-described manner to perform a sequence of such prescribed movements, and measurements of actual movement thereof may be stored and used as input to calibration, e.g. to calibrate a camera (for use in Augmented Reality) or other sensor.

It is to be understood that several other aspects of the invention will become readily apparent to those skilled in the art from the description herein, wherein it is shown and described various aspects by way of illustration. The drawings and detailed description are to be regarded as illustrative in nature and not as restrictive.

### BRIEF DESCRIPTION OF THE DRAWINGS

FIGS. 1A and 1B illustrate a game of prior art, wherein a user tilts device 101 to move a ball into a hole.

FIGS. 1C-1F illustrate an example of instructing a user to position device 101 on surface 110 in the prior art.

FIG. 1G illustrates another example of instructing a user to move device 101 in the prior art.

FIGS. 2A-2F illustrate an example of instructing a user to move device 201 by use of two icons R and T on screen 202, in several described embodiments.

FIG. 3A illustrates, in a flow chart, operations performed by a processor 300 in device 201 of FIGS. 2A-2F in certain described embodiments.

FIG. 3B illustrates, in an intermediate-level block diagram, a memory 329 coupled to processor 300 of FIG. 3A, in some described embodiments.

FIGS. 4A and 4B illustrate another example of instructing the user to move device 201 by use of a single icon D on screen 202, in several described embodiments.

FIG. 4C illustrates, in another flow chart, operations performed by processor 300 in device 201 to show the single icon D on screen 202 of FIGS. 4A and 4B in certain described embodiments.

FIGS. 5A-5H illustrate another example of instructing the user to move device 201 by use of two icons R and T on screen 202 to perform a sequence of three movements that constitute an inverted U shape in the English language, in many described embodiments.

FIG. 6 illustrates, in a high-level block diagram, various components of a device 201 in some of the described embodiments.

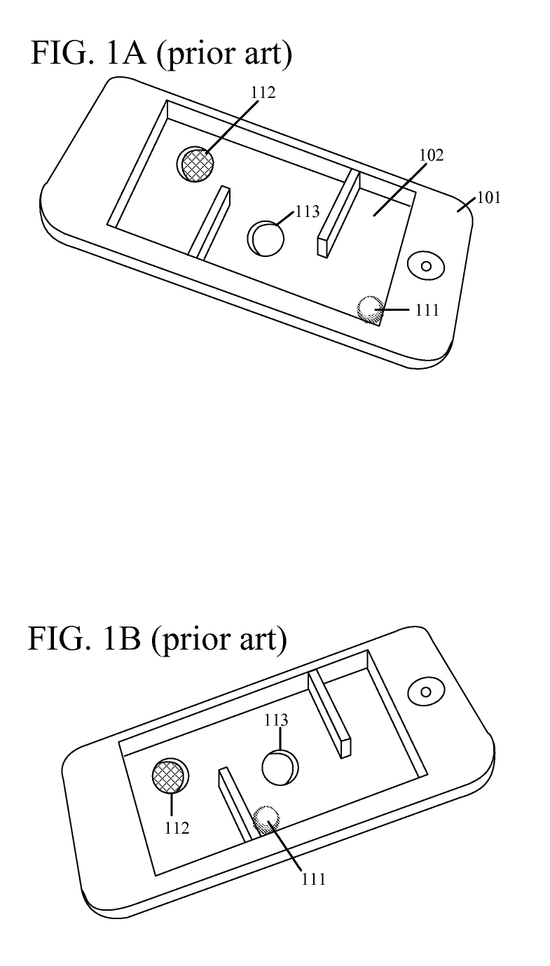

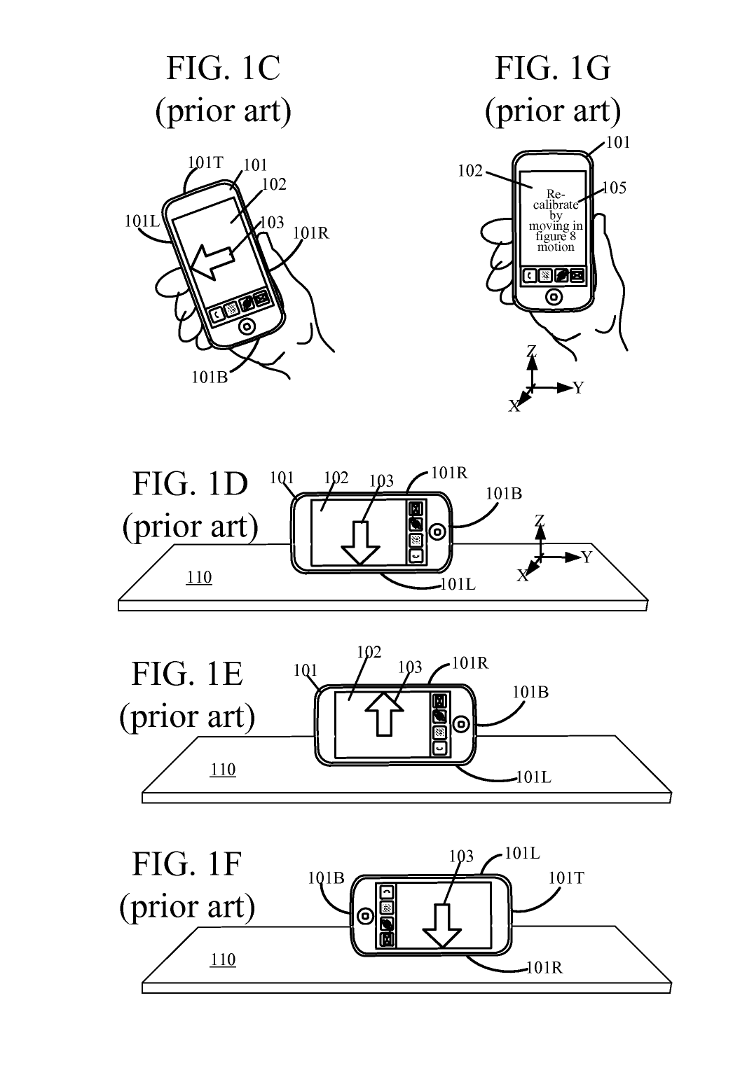

### DETAILED DESCRIPTION

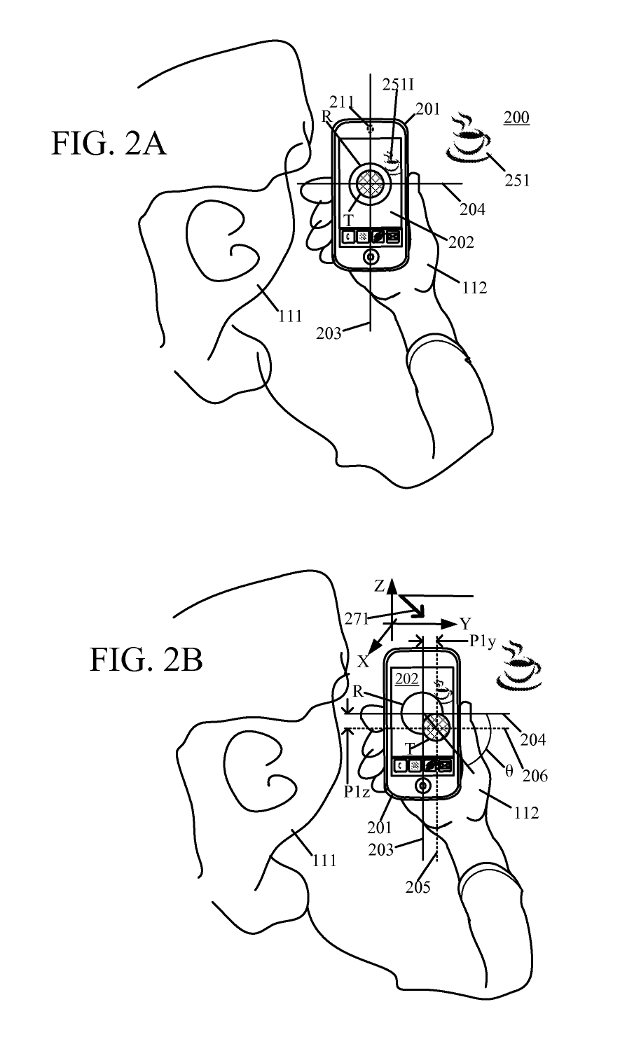

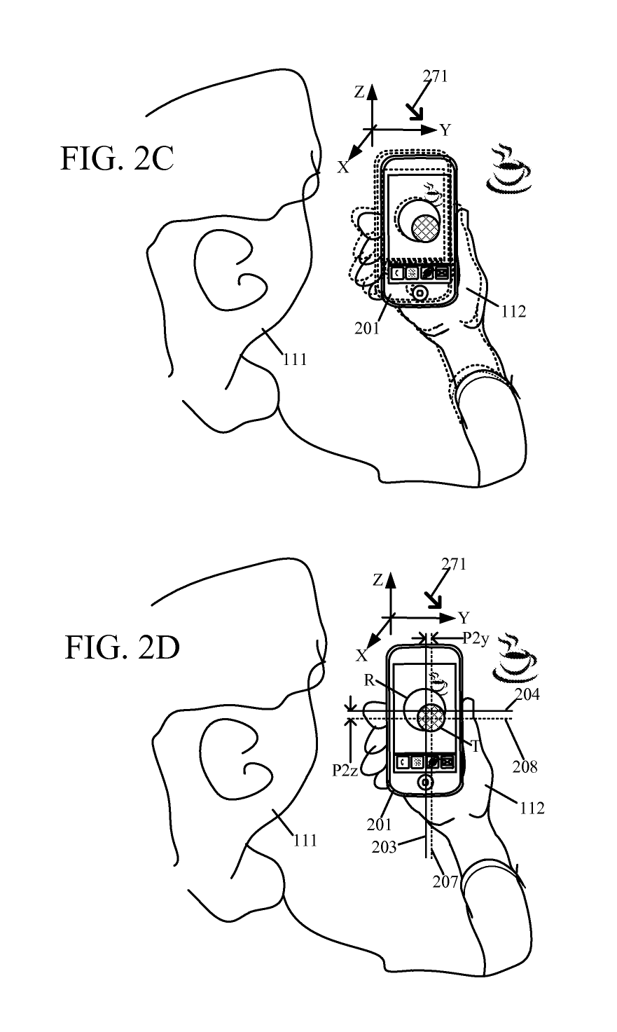

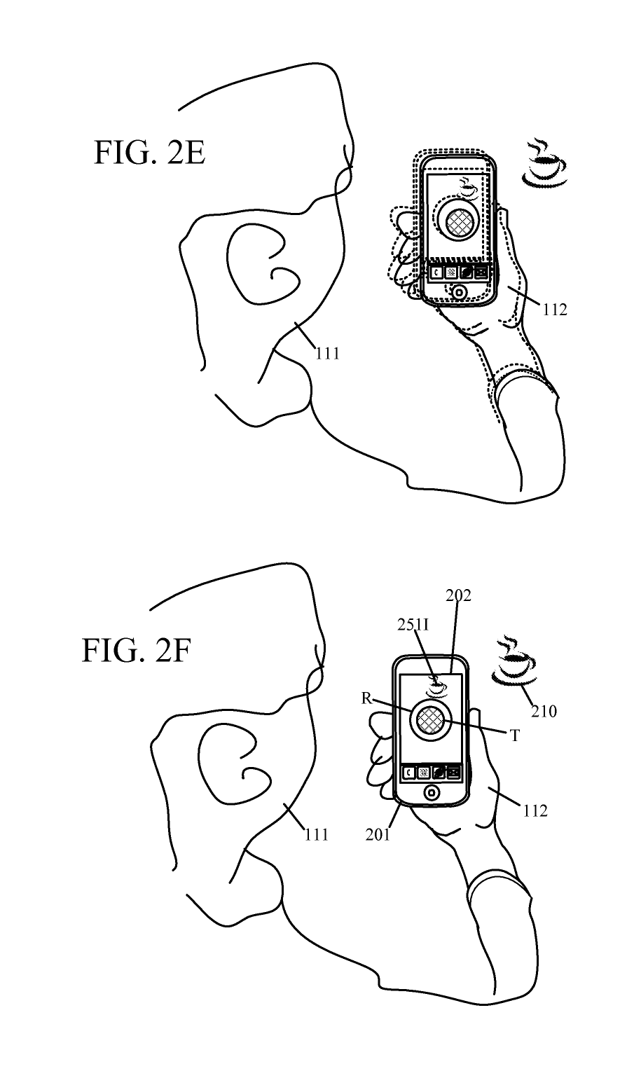

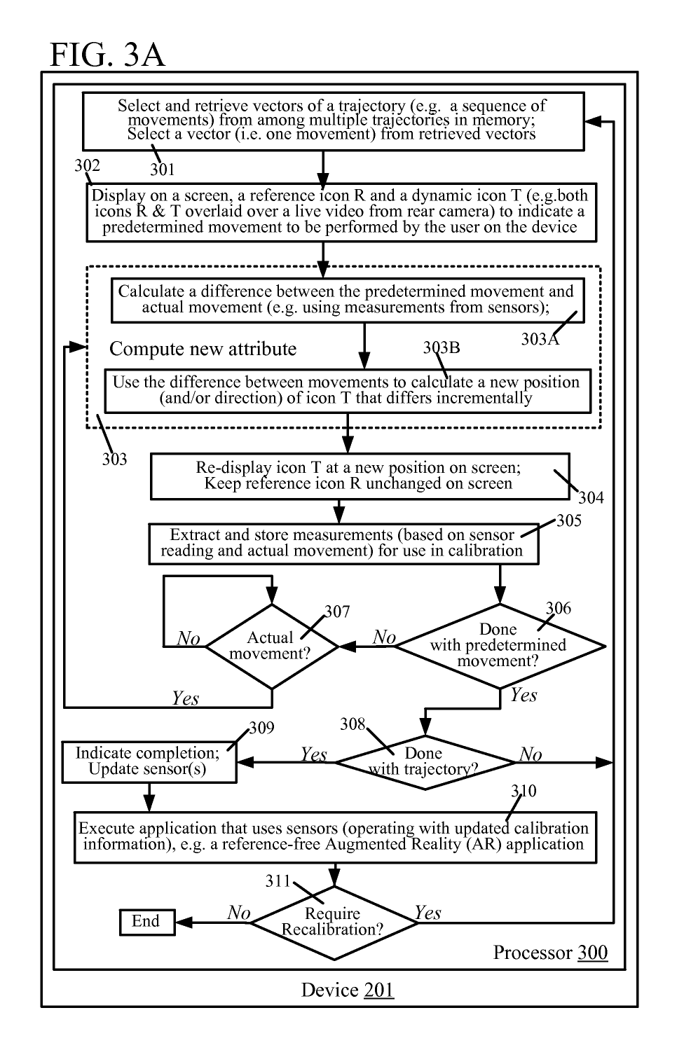

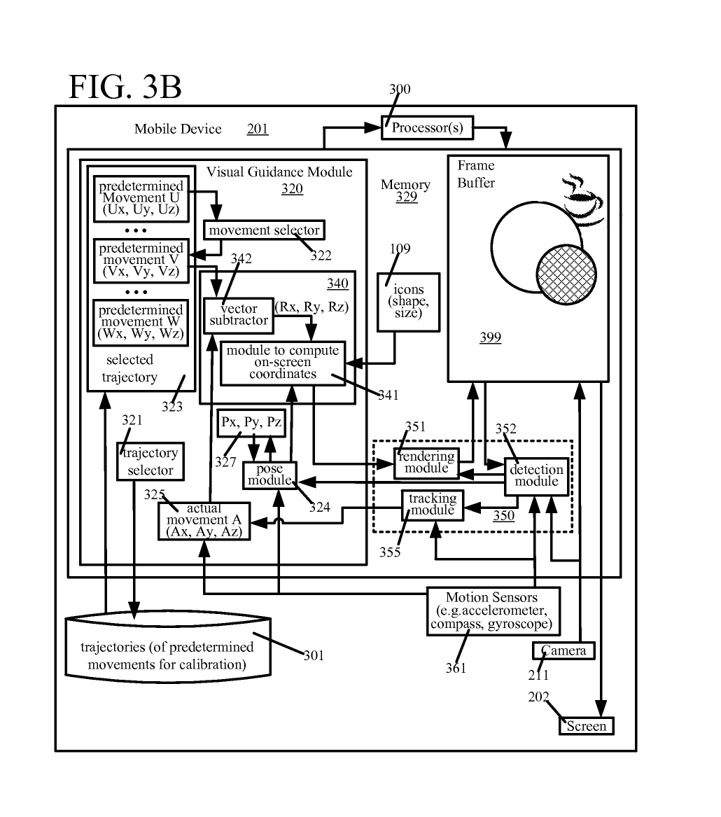

In several of the described embodiments, one or more visual cues are used to instruct a user to move a handheld device in real world through a movement that is predetermined (also called “predetermined movement” or “prescribed movement”). Specifically, in some embodiments, a handheld device 201 (such as a smartphone, e.g. iPhone from Apple, Inc.) displays on a screen 202 (FIG. 2A) as per an act 302 (FIG. 3A), two icons R and T in the form of circles, although shapes other than circles (such as square, diamond, ellipse, triangle, or any icon, such as a user-supplied image 109 in FIG. 3B) may be used in other embodiments. In the example illustrated in FIG. 2A, a user 111 is shown holding device 201 in the right hand 112, although in other examples device 201 may be held in the left hand (not shown).

When no movement is to be performed on handheld device 201, icons R and T are displayed on screen 202 concentric relative to one another as shown in FIG. 2A. More specifically, in some embodiments illustrated in FIG. 2A, icons R and T are shown both positioned at a center of screen 202. In some embodiments, icons R and T are overlaid over a display of a live video on screen 202, the live video being supplied by a camera 211 that is located on a back side of device 201. Accordingly, screen 202 shows to user 111 a display of a scene 200 in the real world, e.g. by displaying an image 2511 of a coffee cup 251 in scene 200 (FIG. 2A).

As would be readily apparent to the skilled artisan in view of this detailed description, the above-described back side (not shown) of device 201 is located opposite to its front side at which screen 202 is located, with circuitry of the type shown in FIG. 3B being enclosed in a housing that includes the just-described back side and front side. Also as would be readily apparent in view of this detailed description, the center of screen 202 is located at an intersection of two medians 203 and 204 that are perpendicular to one another and oriented along the longitudinal and lateral dimensions of screen 202 (e.g. parallel to a y-axis and to a z-axis respectively in FIG. 2B). The position of icon T at the center of screen 202 is also referred to herein as its normal position.

In the above-described embodiments, icon R is always kept stationary on screen 202 (also called “reference-icon”) at its initial position (e.g. at the center of screen 202), regardless of any movement that has been previously performed on handheld device 201, regardless of any movement that is currently being performed on handheld device 201, and regardless of any movement that is yet to be performed on handheld device 201. Hence, in certain embodiments that use icon R, handheld device 201 displays icon R stationary on screen 202. However, note that several alternative embodiments do not use icon R, and instead the user is instructed to move icon T to the center of screen 202 (even though there is no icon R displayed). Other embodiments may display icon R only temporarily, when displaying written text for user guidance.

In contrast to the stationary icon R, handheld device 201 displays the above-described icon T (also called “dynamic icon”) with an attribute (such as its position on screen 202, or its dimension such as the length of an arrow or the diameter of a circle) whose value is different at different times. Specifically, in certain embodiments of the type illustrated in FIG. 2B, dynamic icon T is initially displayed at an initial position that is offset from the center of screen 202 to indicate a predetermined movement 271 that the user is to perform on device 201. For example, in FIG. 2B, dynamic icon T is displayed offset from reference icon R, towards the bottom right corner of screen 202. In this example, icon T is offset by a distance Y in the horizontal direction (i.e. along the Y axis), and by a distance Z in the vertical direction (i.e. along the Z axis), both computed based on predetermined movement 271.

An offset position of the dynamic icon T is shown in FIG. 2B relative to center position of reference-icon R on screen 202 to indicate to user 111 that handheld device 201 is to be moved to a new position that is downward (toward the ground) and to the right of a current position of device 201. As would be readily apparent to the skilled artisan, icon T can be initially displayed at any position on screen 202, depending on the predetermined movement 271. At this stage, before any actual movement of device 201, the difference in positions between icons T and R visually indicates the predetermined movement 271 that initially needs to be performed on device 201. Next, some embodiments respond to actual movement of handheld device 201 incrementally by moving dynamic icon T on screen 202 in a direction opposite to actual movement in real world, to provide incremental visual feedback to the user.

In FIG. 2B, an initial position (Py, Pz) of icon T at the intersection of lines 205 and 206 is offset from screen 202's center at the intersection of lines 203 and 204 by a distance which is square root of (Py²+Pz²).) The just-described distance is indicative of a corresponding distance through which handheld device 201 is to be moved (e.g. by hand 112 of a human 111) in performing the predetermined movement 271. Moreover, the ratio Pz/Py is tan θ wherein θ is an angle at which handheld device 201 is to be moved through the just-described distance from the current position of device 201 in the real world, in order to perform the predetermined movement 271, so that on its completion icon T reaches the center of screen 202 (as shown in FIG. 2A).

The just-described distances Y and Z on screen 202 (see FIG. 2B) at which icon T is first displayed are obtained in some embodiments from the predetermined vector V which is stored in and retrieved from a memory 301 (FIG. 3B) of device 201 that represents the predetermined movement 271 in coordinates of the real world, as follows. The just-described vector V is first mapped by one or more processors, such as processor 300 (FIG. 3B) included within mobile device 201, into a plane that passes through screen 202 as determined by the tilt or orientation of device 201 relative to ground. Orientation may be included as angles Px, Py, Pz in pose 327 (FIG. 3B) which may be determined by a pose module 324 Such a mapping of vector V is followed by scaling the result of mapping, so as to fit the result of scaling within the dimensions of screen 202 (such that icon T is visible either in whole or in part, when rendered on screen 202).

Several embodiments of the type described herein serve to guide an initialization procedure (including calibration) to allow mobile device 201 to perform tracking with a camera 211. In such embodiments, angles Px, Py, Pz of orientation in pose 327 may be first determined by pose module 324 by use of one or more sensors in device 201 other than a camera. Examples of certain sensors, one or more of which may be used to determine the orientation of mobile device 201 relative to ground, include one or more accelerometer(s), one or more magnetometer(s), and one or more gyroscope(s), or any other orientation sensor. Accordingly, in some embodiments, pose module 324 is operatively coupled to one or more sensors 361 (FIG. 3B) of the type just described, to receive measurements therefrom and to determine pose in six degrees of freedom, namely three degrees indicative of position and three degrees indicative of orientation.

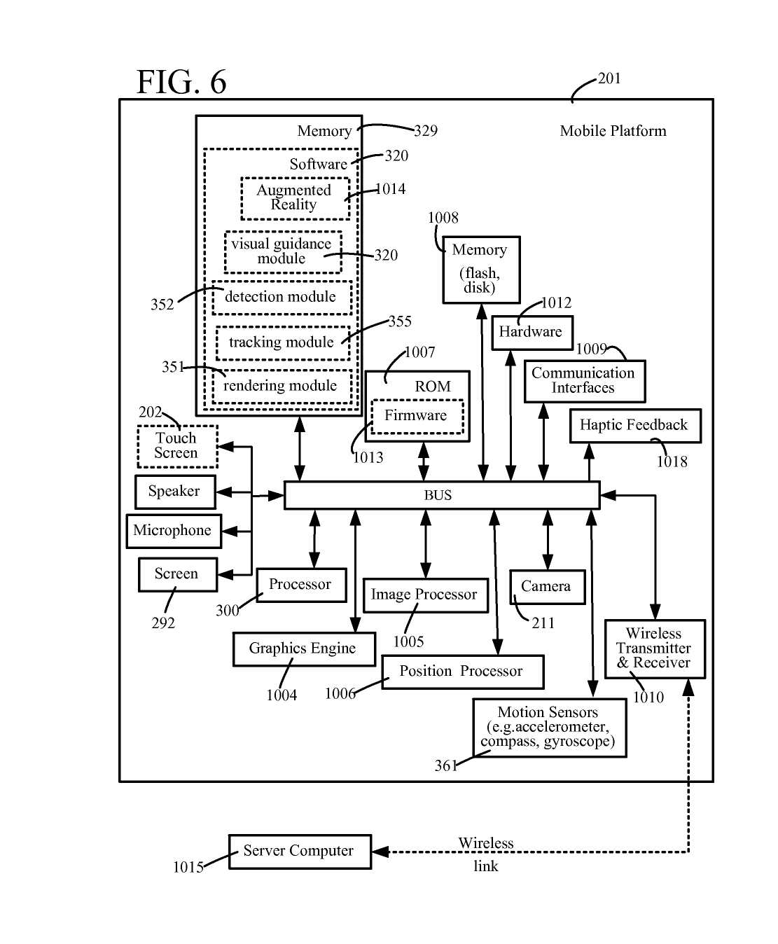

A specific manner in which pose module 324 computes pose (e.g. the position and orientation) of device 201 in real world is different in different embodiments. Alternative embodiments use camera 211 in a boot-strapping manner, to determine orientation in a crude approximation using existing methods, such as optical flow, to guide the user in performing a simple motion. Depending on the embodiment, pose module 324 may compute an initial pose of device 201 (before displaying one or more icons indicative of a prescribed movement on screen 202) by using only information sensed locally by sensors in device 201 or by using only information obtained via one or more wireless link(s) such as a WiFi link and/or a cellular link, e.g. from a server computer 1015 (FIG. 6) or any combination thereof. Such an initial pose, regardless of how it is obtained in device 201, is thereafter updated by pose module 324 of some embodiments as device 201 is moved by an actual movement, e.g. based on measurements from one or more motion sensors 361 in device 201.

As noted above, the vector V of a predetermined movement 271 (shown in FIG. 2B) is stored in a memory of device 201. In one example, vector V is stored in the form of offsets (Vx, Vy, Vz) along three coordinates X, Y and Z in the real world. In another example, vector V is stored in the form of a model of a mathematical function that describes the predetermined movement 271 (FIG. 2B), such as the line z=−y which is a diagonal line that points downward (toward the ground) and to the right (from an origin of the coordinate system).

Such a stored vector V describes a difference, between an original position of mobile device 201 in the real world (the position shown in FIG. 2B) at the beginning of predetermined movement, and a final position of mobile device 201 in the real world (the position shown in FIG. 2F) at the end of predetermined movement. A vector V indicative of a predetermined movement 271 described above may be stored in a memory 329 inside handheld device 201 as one of a sequence of vectors (U . . . V . . . W) stored therein, all of which represent corresponding movements in a trajectory 323 of movements to be performed with handheld device 201 in the real world in the specified sequence (e.g. for calibration). The just-described trajectory 323 may be just one of several such trajectories that may be stored in non-volatile memory 301 of device 201, for use in calibration.

In some embodiments, a trajectory 323 is approximated by a sequence of segments of straight lines, i.e. piece-wise linear line segments each of which is represented by a corresponding vector in the above-described sequence of vectors. As will be readily apparent in view of this detailed description, such a trajectory (including one or more prescribed movements to be performed with the handheld device) can be of any shape, and therefore depending on the embodiment the trajectory includes curves (such as the figure “8”) and/or arbitrary functions. A sequence of vectors may be stored in certain embodiments in a table in memory 329 of device 201 in the form of coordinates of a sequence of points. A difference in coordinates between two adjacent entries in the table is used in such embodiments as vector V that denotes a prescribed movement. This vector V is then used by one or more processors, such as processor 300 within mobile device 201, to display on screen 202 the dynamic icon T offset from the stationary icon R in the direction of vector V and by a distance that is scaled relative to length of vector V (e.g. if length of V is 10 inches in real world, icons T and R are displayed offset by 1 inch).

In some examples, a predetermined movement 271 (FIG. 2B) is selected by design to be entirely within a single plane, e.g. the Y-Z plane (which is a vertical plane perpendicular to ground) or alternatively the X-Y plane (which is a horizontal plane parallel to ground). Note that the (x, y, z) coordinate system in the embodiments of FIG. 2B uses the Z-axis oriented vertically upward relative to ground, and hence a depth vector oriented away from the user points in the −X direction in FIG. 2B. In other embodiments which are not shown, the (x, y, z) coordinate system is oriented to point the Z-axis away from the user (and denote the depth vector). In the just-described examples, as one dimension (e.g. depth in case of the X-Y plane) is absent, the size of icon T does not change (relative to the size of icon R), when the movement is being performed on device 201. However, other examples of such movements include all three dimensions, and in such other examples a property (such as size or color) of icon T may be changed in some embodiments to indicate movement prescribed to be performed in a third dimension. For example, a user may be notified via written text (displayed prior to actual movement) that when the size of icon T (e.g. diameter of a circle) is larger than the size of icon R (e.g. diameter of another circle), device 201 is to be moved farther away from the user (along a depth vector in the −X direction in FIG. 2B), while at the same time relative positions of icons T and R indicate movement to be performed in a vertical plane in front of the user (e.g. the Y-Z plane in FIG. 2B).

An initial step in some embodiments is to select and retrieve (e.g. as per act 301 in FIG. 3A) vectors of a trajectory 323 from among multiple trajectories stored in memory 301, and thereafter to select a specific vector (such as vector V) from among the retrieved vectors. The just-described functions may be performed by execution of instructions (also called software instructions or computer instructions) 321 and 322 by one or more processors, such as processor 300 (which, during such execution, may function respectively as “trajectory selector” and “movement selector”) as illustrated in FIG. 3B.

After performance of act 301, in act 302 (FIG. 3A), a reference icon R is displayed at the center position (0, 0, 0) of screen 202 (FIG. 2B) and at the same time dynamic icon T is displayed at the above-described position P1 with the coordinates (P1y, P1z) on screen 202. Dynamic icon T remains at this position P1 unchanged while device 201 remains stationary in the real world. In some embodiments (called “translation embodiments”) dynamic icon T also remains at this position P1 unchanged while mobile device 201 is simply tilted or rotated in the real world, i.e. when there is no translation of device 201. Although translation embodiments that are sensitive to translation of device 201 are described below, other embodiments of device 201 that are sensitive to other movement, such as rotation or tilting will be apparent to the skilled artisan in view of this detailed description.

As soon as handheld device 201 is moved, the movement is sensed e.g. by motion sensors 361 (or alternatively by a detection module 352 in FIG. 3B comparing successive images in a video feed from camera 211) to detect motion, which is followed by tracking module 355 computing a vector A from one or more measurement(s) of actual movement as (Ax, Ay, Az). Translation embodiments require a user to translate handheld device 201 in order to cause a display on screen 202 of dynamic icon T to be updated. To re-iterate, in the translation embodiments, the display of dynamic icon T does not change relative to reference icon R if there has been no translation, i.e. when movement of device 201 is only rotating or tilting.

When a user performs any movement on device 201, a translation component in the actual movement is automatically measured in a measurement by a translation sensor (such as a gyroscope) that is included in the translation embodiments of handheld device 201. Then, a vector A is computed based on one or more measurements by the translation sensor, and this vector A denotes translation of device 201 subsequent to display of icon T initially identifying the predetermined movement. Hence, in response to actual movement of device 201 which includes translation (change in position) denoted by vector A, one or more processors such as processor 300 automatically compute(s) a revised value for an attribute of dynamic icon T (in this example the attribute is the on-screen position, although in other examples the attribute is a dimension). Device 201 may use any known methodologies (depending on sensors therein), to measure and compute various parameters, such as pose of device 201 relative to ground, in addition to vector A.

At this stage, a revised value (e.g. a first new position P2 of icon T) is computed (see operation 303 in FIG. 3A), by first calculating an instantaneous to-be-performed movement, as the difference between vector V of the predetermined movement and vector A of the actual movement that has occurred subsequent to displaying of icon T at initial position (Y, Z) at the intersection of lines 205 and 206 (FIG. 2B). Next the instantaneous to-be-performed movement is used to compute a new position P2 at coordinates (P2y, P2z) for icon T, e.g. by scaling the difference. After operation 303, icon T is re-displayed (as per act 304 in FIG. 3A) on screen 202 at the new position P2 as shown in FIG. 2D, and icon R is still displayed stationary at the center of screen 202.

In several embodiments, in an act 305 following act 304, certain calibration information is extracted, e.g. based on a measurement by a sensor, such as a gyroscope. Such calibration information is stored in memory 329 for later use in device 201 to initialize instructions of software to be executed by one or more processors (e.g. processor 300), such as Augmented Reality software 1014 (FIG. 6), which may use one or more reference free functions (e.g. based on optical flow). In one such example, a prescribed movement and its corresponding calibration information are used to initialize or calibrate Augmented Reality software 1014 executed by one or more processors (e.g. processor 300) that in turn super impose(s) information (such as icons R and T in FIG. 2A) on (or otherwise modify) images in a live video feed from camera 211, with resulting images being displayed on screen 202. As shown in FIGS. 2A-2F, the resulting images include one or more icons R and T as described above, as well as an image 2511 of a cup 251 in the real world, e.g. as a video of augmented reality (AR).

After performing act 305, in an act 306 a processor 300 checks if the predetermined movement has been completed, and if the answer is no, then loops back to operation 303 e.g. after checking in act 307 that there is actual movement of the type shown in FIG. 2E. Then, in a repetition of operation 303, processor 300 computes a second new position P3 and in a repetition of act 304 processor 300 re-displays icon T at the new position P3 (see FIG. 2F). Note that the new position of device 201 in FIG. 2F is identical to the position of device 201 in FIG. 2E, but FIG. 2F is shown without the dashed lines in FIG. 2E which represent the intermediate position P2 of device 201, as first shown in FIG. 2C. Icon T in FIG. 2F is shown at the second new position P3.

Note that although only a single processor 300 is referred to in some portions of this detailed description, as will be readily apparent, one or more processors may be used. Moreover, the above-described repetition of operation 303 and act 304 is performed multiple times at a rate that depends on processing power available in device 201. In some embodiments, operation 303 and act 304 are repeatedly performed in the loop several times each second, so that the position of icon T is incrementally updated on screen 202 multiple times a second (frame rate>1/sec).

In several embodiments, a difference between two positions P1 and P2 of dynamic icon T as displayed in two successive frames (shown on screen 202 in FIGS. 2B and 2D respectively) is correspondingly small, and the rate of iteration is sufficiently fast so as to provide an appearance of continuous movement of icon T to a human eye of a user. Hence, additional new positions P3 . . . Pi . . . Pz are incrementally computed at which dynamic icon T is repeatedly re-displayed, thereby to visually present an appearance of icon T moving on screen 202 in response to any actual movement of device 201 in real world.

As noted above, each position Pi of icon T on screen 202 indicates a movement (called “instantaneous to-be-performed movement”) that is to be now performed by the user in the real world on device 201. The instantaneous to-be-performed movement is repeatedly computed as device 201 is moved (or not moved) by the user. As shown in FIG. 2C, device 201 may be initially moved, e.g. in an attempt by user 111 to perform the predetermined movement 271 in whole or in part. A new position of device 201 in FIG. 2D is identical to the position of device 201 in FIG. 2C, but FIG. 2D is shown without the dashed lines in FIG. 2C which represent the initial position of device 201, as first shown in FIG. 2B.

A new position P1 of icon T in FIG. 2D is at the intersection of lines 207 and 208 which are parallel to the above-described medians 203 and 204. Notice that an overlap between icons R and T (compare FIGS. 2A and 2D) increases as the position of icon T is incrementally updated in a direction opposite to vector V in response to device 201 being moved by the user as indicated by vector V (e.g. until icon T reaches the center of screen 202).

A user 111 may make a mistake and not move device 201 in accordance with a prescribed movement V indicated by icon T on screen 202. If the actual movement by the user happens to be incorrect (i.e. not in accordance with the prescribed movement), the display on screen 202 is updated by performance of operation 303 and act 204 to show icon T farther away from and/or at a different direction relative to icon R. In some embodiments, when actual movement A of device 201 in the real world is different from vector V of the predetermined movement, a corresponding position of icon T on screen 202 is changed appropriately, based on the vector difference between vectors A and V.

As will be readily apparent to the skilled artisan, depending on the rate of loop back, dynamic icon T may be displayed on screen 202 as moving intermittently (when loop back rate is low, e.g. once per second) or continuously (when the loop back rate is high, e.g. thirty times per second). Specifically, computation and re-display in operation 303 and act 304 respectively are repeated in many embodiments at least 10 times per second or more, while device 201 is being moved in the real world, and while the predetermined movement has not been completed. In some embodiments, the above-described loop back is performed at least at a rate that is fast enough to match a frame rate of camera 211 in some embodiments that show continuous movement of icon T on screen 202 based on persistence of human vision, in response to continuous actual movement of device 201 in the real world.

As noted above, in several embodiments, during performance of operation 303, each new position of dynamic icon T (FIG. 2D) is computed in two steps, first by calculating (as per act 303A) a difference between the vector V of prescribed movement 271 and the vector A of actual movement as determined from measurements by one or more sensors in handheld device 201, followed by calculating (as per act 303B) a new position of icon T using the just-described difference and a pose of device 201. Specifically, in act 303A, an instantaneous to-be-performed movement (in the real world) is determined as the vector difference D=V−A, e.g. by use of a vector subtractor 342 (FIG. 3B). Vector subtractor 342 may be implemented by, for example, one or more processors 300 executing computer instructions thereto that are stored in memory 329.

The difference D described in the preceding paragraph is used to determine coordinates of a new position of icon Ton screen 202, e.g. in act 303B performed in a module 341 to compute on-screen coordinates. Module 341 may be implemented by, for example, one or more processors 300 executing computer instructions thereto that are stored in memory 329. A maximum displacement of icon T from icon R is initially determined by module 341 to be such that icon T can be displayed in its entirety on screen 303 of the mobile device 201 (i.e. not so far away that icon T is either wholly or partially outside of screen 303). The maximum displacement determines a scaling factor that is then used by module 341 to perform act 303B in updating the coordinates of icon T on screen 202 in response to actual movement of device 201 (denoted by vector A). Scaling of difference D by module 341 in act 303B may be linear and fixed in some embodiments, and non-linear or variable in other embodiments as described below. Accordingly, a vector subtractor 342 and coordinate computation module 341 are included a module 340 of some embodiments, and module 340 itself is included in a visual guidance module 320 in memory 329 of mobile device 201.

In several embodiments, each frame of live video captured by a camera 211 of device 201 is stored in memory 329 in a frame buffer 360. After a frame is stored in buffer 360, that frame is edited by a rendering module 351 overwriting therein the icon T at a position that has been computed as described above (based on actual movement) and optionally the icon R at the center. The result of such overwriting is an edited frame that includes an image of scene 200 (such as image 2511 as well as icons R and T, and this edited frame is then displayed on screen 202 as a frame of a video of augmented reality (AR), before a new frame from the live video is stored in frame buffer 360.

In some embodiments, overwriting of a frame (as described in the preceding paragraph) is done in another area of memory 329 used as a temporary buffer (not shown). The contents of such a temporary buffer may be then copied to the frame buffer 360 for display on screen 202, followed by overwriting the temporary buffer with a new frame from camera 211. Hence, in response to continuous movement of device 201 in real world, dynamic icon T (FIG. 3B) is repeatedly re-drawn at different positions relative to, for example, a boundary of the frame, so as to provide an appearance of continuous movement of icon T on screen 202.

A rendering module 351 (FIG. 6) of several embodiments may be configured to implement a means for displaying on screen 202 (e.g. by using processor 300 to execute a group of first instructions to update a frame buffer 399 of FIG. 3B in memory 329 that is operatively coupled to screen 202) and means for re-displaying on screen 202 (e.g. as processor 300 to execute a group of second instructions to update the frame buffer 399) the following: at least an icon (dynamic icon) having an attribute which has a value that is revised based on an instantaneous to-be-performed movement. As noted above, visual guidance module 320 (FIG. 3B) of some embodiments implements means for computing such a revised value for the attribute (e.g. as processor 300 coupled to memory 329), to ensure that the instantaneous to-be-performed movement depends at least on a predetermined movement to be performed and a measurement by a sensor of movement of device 201 in real world (also called actual movement).

As noted above in reference to FIG. 3B, in implementing the means described in the preceding paragraph, rendering module 351 and visual guidance module 320 may be configured to display an additional icon (reference icon) on the screen at a fixed location (e.g. as processor 300 coupled to memory 329), simultaneous with an initial display of the dynamic icon with the initial value of the attribute, and also simultaneous with re-display of the dynamic icon with the revised value of the attribute. Visual guidance module 320 (FIG. 3B) of some embodiments may also implement (e.g. as processor 300 coupled to memory 329), a means for repeatedly triggering operation of the following: the means for computing and the means for re-displaying (e.g. as processor 300 coupled to memory 329), such that the attribute of the dynamic icon changes in frame buffer 399 and thereby on screen 202 (FIG. 3B) based on at least the predetermined movement and additional measurements by the sensor of additional movements of device 201 in the real world.

In many of the described embodiments, an attribute of dynamic icon T as displayed on screen 202 (FIG. 3B) indicates an instantaneous to-be-performed movement at several moments in time, and hence user 111 (FIG. 2A) receives visual feedback by viewing icon T displayed on screen 202, and based on the feedback the user 111 may continue an initially started movement in the real world, in an attempt to move handheld device 201 such that icon T is returned to its normal position (at a center of screen 202 as shown in FIG. 2F), thereby to successfully perform the predetermined movement V. In some embodiments, the visual feedback provided after the initially started movement in the real world is supplemented (e.g. via audio feedback through a speaker in device 201) or accentuated in the display on screen 202 (e.g. by changing an attribute of icon T to make icon T flashing), when the user fails to continue the initially started movement, e.g. within a predetermined amount of time (such as 1 second).

On completion of the predetermined movement V, processor 300 checks in act 308 (FIG. 3A) if the trajectory selected in act 301 has been completed, and if not returns to act 301 to pick another predetermined movement in the selected trajectory. When performance of a first predetermined movement of a trajectory is completed, the above-described displaying in act 302, the computing in operation 303, the re-displaying in act 304 are again performed, now with a second predetermined movement that is specified in a sequence of predetermined movements that constitute the selected trajectory.

Hence, although in some embodiments icon T is displayed at the center of screen 202 on completion of the first predetermined movement, in other embodiments a new position of icon T is again computed, based on the second predetermined movement, e.g. when a selected trajectory includes a plurality of predetermined movements. For example, as a user moves device 201 through the first predetermined movement, towards bottom right as shown in FIG. 2E, icon T is moved to the right in addition to being moved upwards, when a selected trajectory includes a corresponding additional predetermined movement.

If performance of all predetermined movements in a selected trajectory is completed, then in act 309, processor 300 indicates successful completion to the user e.g. by vibrating device 201 and/or by playing an audible message through a speaker to state “calibration complete” or by overwriting a frame in frame buffer 360 with a string of text to be displayed on screen 202 also to state “calibration complete” or by no longer overwriting icon T (and optionally icon R) in frame buffer 360. At this stage, the calibration information that was extracted during the repeated performance of act 305 (described above) is used to initialize AR software and/or to calibrate one or more sensors.

After act 309, device 201 is ready for use in the normal manner, e.g. processor 300 is used in act 310 to execute any application, such as reference free augmented reality software 1014 that uses sensors (with calibration information extracted in the repeated performance of act 305). Subsequently, at some point in time, an act 311 is performed to check if device 201 requires re-calibration and if so processor 300 returns to act 301 (described above). If no re-calibration is required as per act 311, processor 300 then ends the method described above (acts 301-311) until this method is again invoked in future (e.g. by user).

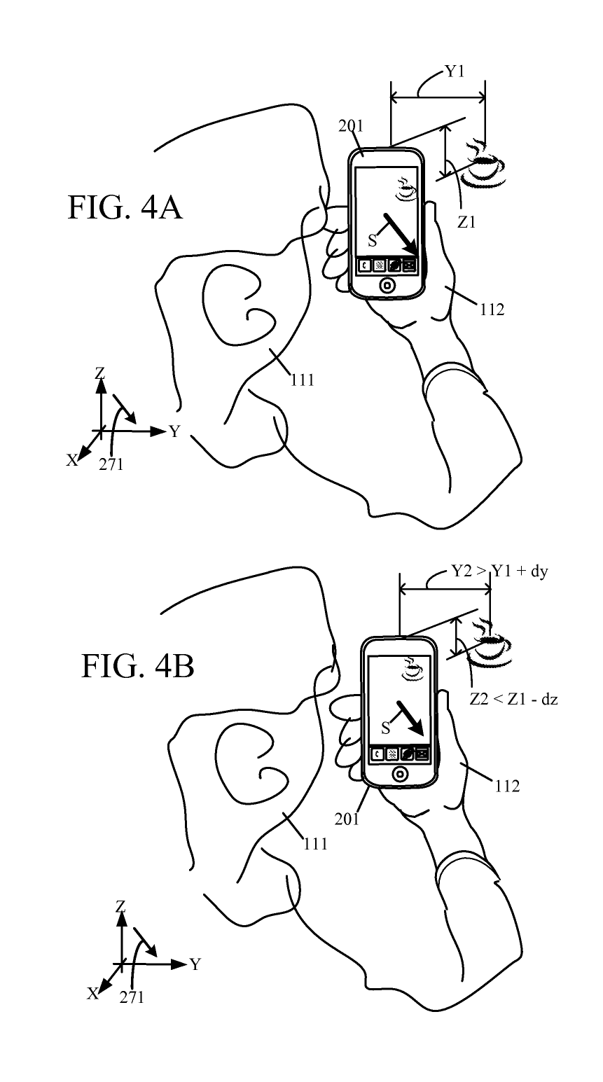

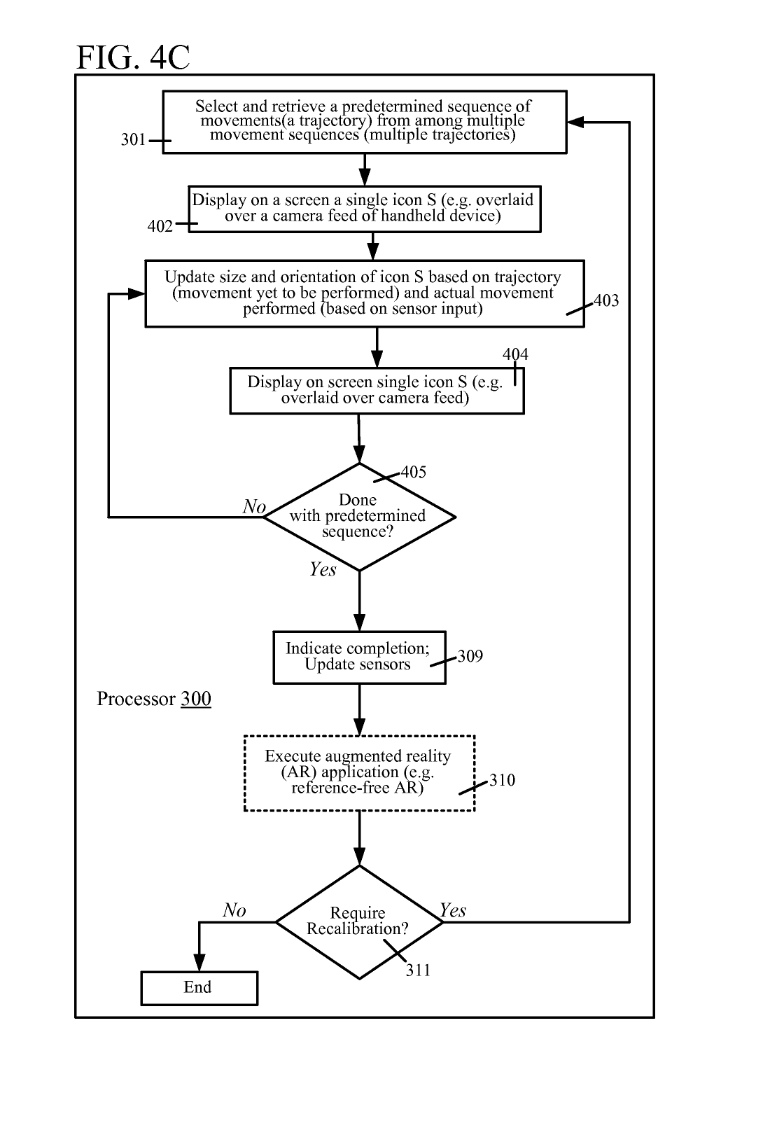

Although two icons R and T are shown and described above in reference to FIGS. 2A-2F, some embodiments simply omit icon R, i.e. use only icon T as described above. Other such embodiments use a single icon S e.g. an arrow (see FIG. 4A) that would connect icons R and T if present (which are in fact not present in these embodiments). Accordingly, in response to an initial display of the single icon S (also called dynamic icon) on screen 202 (FIG. 4A), the user 111 moves handheld device 201 at least in the direction indicated by the icon S e.g. at least in the vertical plane Y-Z diagonally downward (e.g. −dz) to the right (e.g. dy) as shown in FIG. 4B (and in this example, any movement along the X axis (or depth vector) is either not sensed or if a non-zero value of dx is sensed it is disregarded). In such embodiments, as illustrated in FIG. 4C, an act 301 is initially performed as described above, followed by act 402 to display the single icon S on screen 202 as shown in FIG. 4A. The single icon S may be displayed on screen 202 overlaid on images of a live video from a camera feed as described above (e.g. icon S and image 2511 of FIG. 2A are both shown in a single frame on screen 202), although in other embodiments no information from a live video is displayed on screen 202.

Thereafter, in act 403, as device 201 is moved by the distance (0, dy, −dz) from its initial position at coordinates (0, Y1, Z1) as shown in FIG. 4A to a new position at coordinates (0, Y2, Z2) as shown in FIG. 4B, an attribute of icon S is automatically updated, e.g. the length and/or orientation of the arrow is updated, in a manner similar to operation 303 described above, i.e. based on an instantaneous to-be-performed movement computed as a difference between actual movement and a predetermined movement. Icon S is displayed on screen 202 in FIG. 4B with the updated attribute (e.g. of smaller length than an initial length shown in FIG. 4A) as per act 404, followed by returning to act 403 to re-draw icon S repeatedly (of smaller and smaller lengths), in response to actual movement of device 201 in the direction of the prescribed movement. Processor 300 also performs acts 309-311 as described above in using the single icon S, instead of two icons R and T.

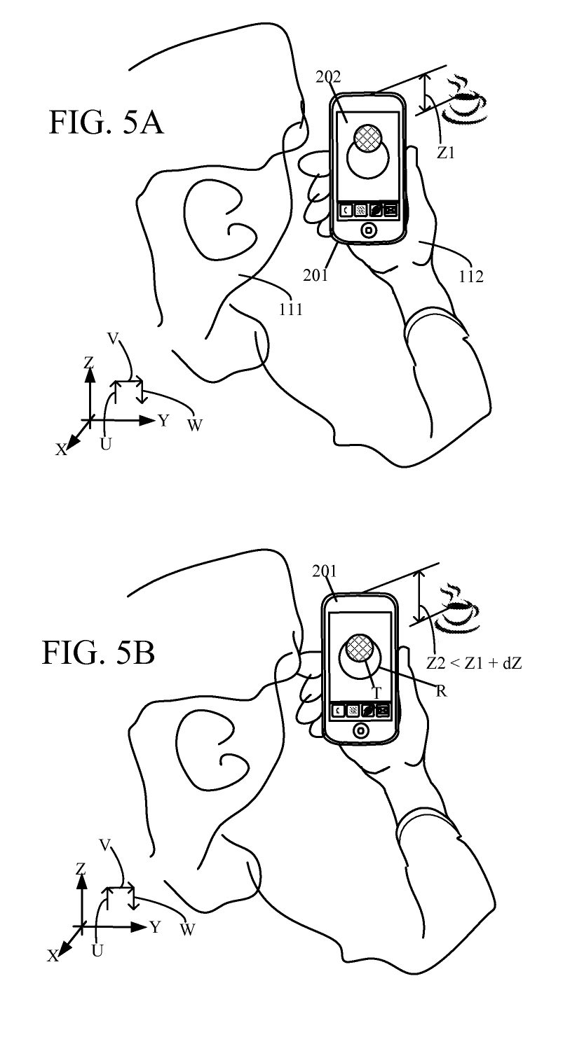

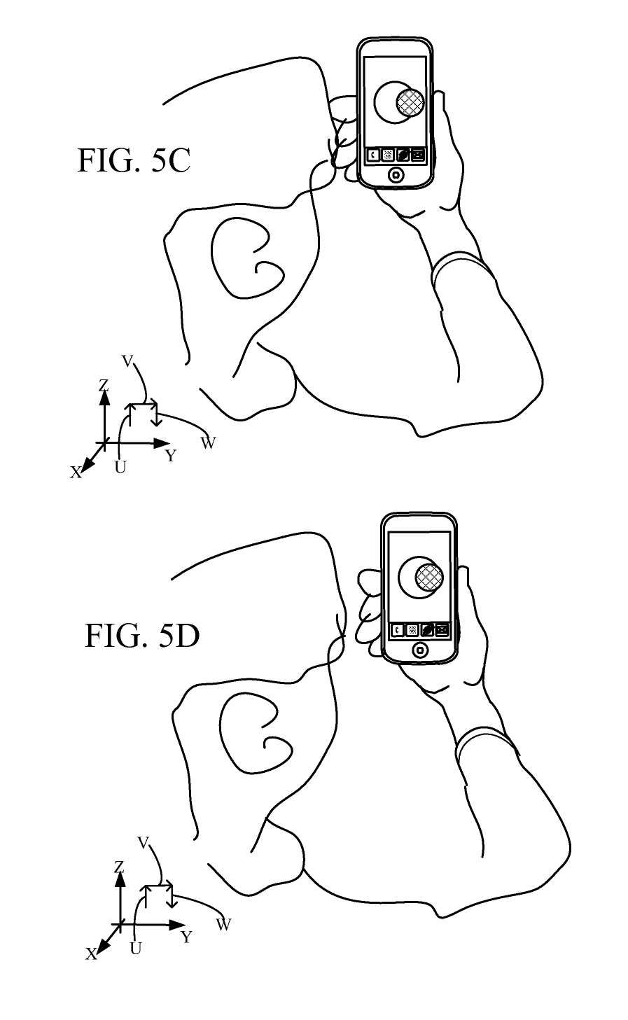

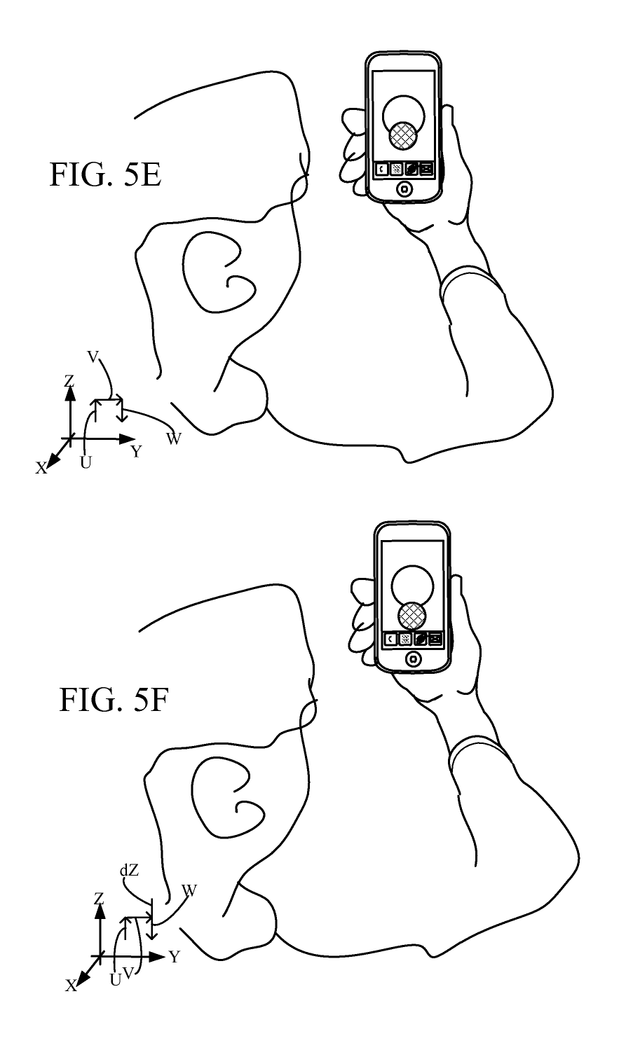

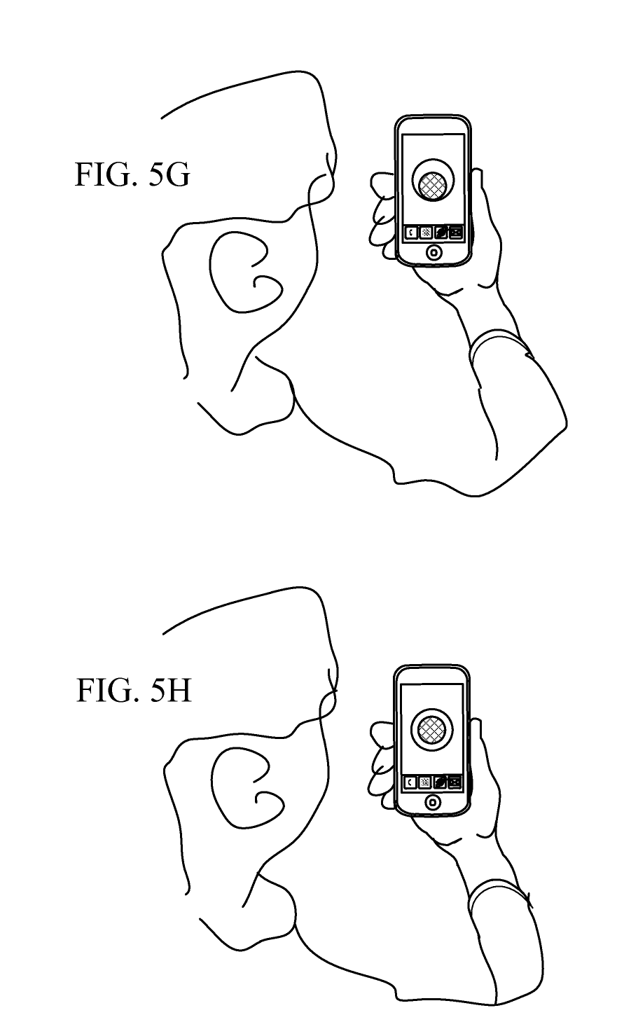

An example of a trajectory which includes a sequence of three predetermined movements is illustrated in in FIG. 5A, requiring a user 111 to move device 201 upwards to perform a first predetermined movement U, then move device 210 to the right to perform a second predetermined movement V, and then move device 210 downward to perform a third predetermined movement W. Specifically, in FIG. 5A, user 111 is instructed to move device 201 upwards by dynamic icon T drawn offset relative to a center of reference icon R in the vertical direction (with a positive upwards offset). As soon as user 111 moves device 201 upwards, dynamic icon T is re-drawn (see FIG. 5B), at an offset from the center of reference icon R, and then repeatedly re-drawn so as to provide a feedback to user 111. Accordingly, in embodiments illustrated in FIGS. 5A-5H, a direction between dynamic icon T and reference icon R on screen 202 at all times indicates a corresponding direction of movement in the real world to be performed by user 111.

A scaling factor that is used to re-draw icon T may be non-linear, e.g. different at different positions of icon T. Specifically, the scaling factor may be automatically reduced as icon T is moved closer to icon R on screen 202, so that the feedback to user 111 is initially accentuated and gradually reduces. In one example, dynamic icon T is made stationary relative to reference icon R when their positions become coincident, i.e. when the vertical movement is completed (which is a first movement in this sequence).

Hence, an initial offset between dynamic icon T and reference icon R may be first changed by an initial scaling factor (which depends on the units of distance used in the real world and corresponding units used on the screen) to initially notify the user (by visual feedback displayed on screen 202) that the user's actual movement of device 201 is in a correct direction, and this initial scaling factor may be thereafter exponentially reduced (e.g. as icon T reaches at a center position where icon R is displayed, and a final scaling factor can be less than 1).

On completion of the first predetermined movement U, a second predetermined movement V in this sequence is used as shown in FIG. 5C to re-draw dynamic icon T at a new position that is offset towards the right of the center of reference icon R, i.e. offset in the horizontal direction. Once again, as soon as user 111 starts moving device 210 to the right, dynamic icon T is initially re-drawn (see FIG. 5D) to the right from the center of reference icon R, and repeatedly re-drawn to provide feedback to the user until the icons R and T coincide (when predetermined movement V is completed).

Note that in the described embodiments, at any stage that device 201 is not moved, dynamic icon T remains stationary on screen 202. Furthermore, dynamic icon T is kept stationary in the above-described example when the user completes the respective movements U and V. However, if the actual movement of device 201 does not match the direction of the to-be-performed movement for any reason (e.g. due to a mistake by the user in moving device 201 differently from a prescribed movement), dynamic icon T may be re-drawn appropriately, e.g. at the same radial offset but in a direction different from or even opposite to actual movement by user 111.

Finally, a third predetermined movement W in this sequence is used as shown in FIG. 5E to re-draw dynamic icon T at a new position offset downwards from the center of reference icon R, i.e. offset in the negative vertical direction Z. If the user makes a mistake by moving device 201 upwards by distance dZ as illustrated in FIG. 5F, the motion by the user is sensed and used to re-draw dynamic icon T at a position that is further offset downwards from the center of reference icon R to provide feedback to the user about an extra distance to be traversed in the upward direction. FIG. 5G illustrates the feedback provided to the user as soon as the user starts moving device 201 downwards (dynamic icon T completely overlaps reference icon R). Finally, FIG. 5H shows the display wherein the user has completed the sequence of predetermined movements.

Note that each of movements U, V and W of a sequence of the type described above in some embodiments require at least a component of actual movement of device 201 to be translation and hence any tilting component or rotation in the actual movement is disregarded. Several embodiments of the type described herein display visual guidance on screen 202 for any trajectory in three dimensions (3-D), or any trajectory of an arbitrary curve in a plane, or any straight line, and any tilting or rotation component in the user's actual movement is ignored so that only the translation component of the actual movement is used to provide feedback via the visual guidance displayed to the user. In some alternative embodiments, a displacement of dynamic icon T (i.e. a distance between successive positions of icon T) shown on screen 202 is proportional to actual movement which the user has already executed in the real world, on device 201.

As noted above, in some embodiments, handheld device 201 includes a camera 211 that displays on screen 202 a video of a real world scene behind handheld device 210 (see FIGS. 2A-2F). However, as will be readily apparent in view of this detailed description, other embodiments may use a handheld device that does not have a camera at all, e.g. as shown in FIGS. 5A-5H. For example, in FIG. 5B, the user 111 has moved device 201 vertically upward (in the positive Z direction) relative to the position shown in FIG. 5A, and accordingly icon T is shown closer to the center of screen 202 in FIG. 5B although no video is displayed on screen 202.

Furthermore, in some embodiments, performance of a method of the type shown in FIGS. 3A, 4C is initiated only after performing proximity sensing by handheld device 201 to detect that handheld device 201 is being held in a hand, which indicates that the user is ready to perform the movements indicated on screen 202 as described above.

Device 201 of some embodiments is a mobile device, such as a smartphone that includes a camera 211 (FIG. 6) of the type described above to generate frames of a video of a real world object that is being displayed on screen 202. As noted above, mobile device 201 may further include various sensors 361 that provide measurements indicative of actual movement of device 201, such as an accelerometer, a gyroscope, a compass, or the like. Device 201 may use an accelerometer and a compass and/or other sensors to sense tilting and/or turning in the normal manner, to assist processor 300 in determining the orientation and position of mobile device 201 relative to ground. Instead of or in addition to sensors 361, device 201 may use images from a camera 211 to assist processor 300 in determining the orientation and position of mobile device 201. Also, mobile device 201 may additionally include a graphics engine 1004 and an image processor 1005 that are used in the normal manner. Mobile device 201 may optionally include detection module 352, tracking module 355 and rendering module 351 (e.g. implemented by a processor 300 executing instructions thereto that are stored in memory 329) to support AR functionality.

In addition to memory 329, mobile device 201 may include one or more other types of memory such as flash memory (or SD card) 1008 and/or a hard disk and/or an optical disk (also called “secondary memory”) to store data and/or software for loading into memory 329 (also called “main memory”) and/or for use by processor(s) 300. Mobile device 201 may further include a wireless transmitter and receiver in transceiver 1010 and/or any other communication interfaces 1009. It should be understood that mobile device 201 may be any portable electronic device such as a cellular or other wireless communication device, personal communication system (PCS) device, personal navigation device (PND), Personal Information Manager (PIM), Personal Digital Assistant (PDA), laptop, camera, smartphone, tablet (such as iPad available from Apple Inc) or other suitable mobile platform that is capable of creating an augmented reality (AR) environment.

A mobile device 201 of the type described above may include other position determination methods such as object recognition using “computer vision” techniques. The mobile device 201 may also include means for remotely controlling a real world object which may be a toy, in response to user input on device 201 e.g. by use of transmitter in transceiver 1010, which may be an IR or RF transmitter or a wireless a transmitter enabled to transmit one or more signals over one or more types of wireless communication networks such as the Internet, WiFi, cellular wireless network or other network. The mobile device 201 may further include, in a user interface, a microphone and a speaker (not labeled). Of course, mobile device 201 may include other elements unrelated to the present disclosure, such as a read-only-memory 1007 which may be used to store firmware for use by processor 300.

Also, depending on the embodiment, a device 201 may perform reference free tracking and/or reference based tracking using a local detector in device 201 to detect objects, in implementations that execute augmented reality (AR) software 1014 to generate a user interface. The just-described reference free tracking and/or reference based tracking may be performed in software instructions (executed by one or more processors or processor cores) or in hardware or in firmware, or in any combination thereof.

In some embodiments of device 201, the above-described pose module 324, trajectory selector 321, vector subtractor 342, coordinate computation module 341 and movement selector 322 are included in a visual guidance module 320 that is itself implemented by a processor 300 executing instructions of software 320 in memory 329 of mobile device 201, although in other embodiments any one or more of pose module 324, trajectory selector 321, vector subtractor 342 and movement selector 322 are implemented in any combination of hardware circuitry and/or firmware and/or software in device 201. Hence, depending on the embodiment, various functions of the type described herein may be implemented in software (executed by one or more processors or processor cores) or in dedicated hardware circuitry or in firmware, or in any combination thereof.

Accordingly, depending on the embodiment, any one or more of pose module 324, trajectory selector 321, vector subtractor 342, movement selector 322, coordinate computation module 341 and/or visual guidance module 320 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile platform, and is not to be limited to any particular type of memory or number of memories, or type of media upon which memory is stored.

Hence, methodologies described herein may be implemented by various means depending upon the application. For example, these methodologies may be implemented in firmware 1013 (FIG. 6) or software 320, or hardware 1012 or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. For a firmware and/or software implementation, the methodologies may be implemented with modules (e.g., procedures, functions, and so on) that perform the functions described herein.

Any machine-readable medium tangibly embodying computer instructions may be used in implementing the methodologies described herein. For example, software 320 (FIG. 6) may include program codes stored in memory 329 and executed by processor 300. Memory may be implemented within or external to the processor 300. If implemented in firmware and/or software, the functions may be stored as one or more computer instructions or code on a computer-readable medium. Examples include nontransitory computer-readable media encoded with a data structure (such as a sequence of predetermined movements) and computer-readable media encoded with a computer program (such as software that can be executed to perform the method of FIG. 3A).

Computer-readable media includes physical computer storage media. A storage medium may be any available medium that can be accessed by a computer. By way of example, and not limitation, such computer-readable media can comprise RAM, ROM, Flash Memory, EEPROM, CD-ROM or other optical disk storage, magnetic disk storage or other magnetic storage devices, or any other medium that can be used to store program code in the form of software instructions (also called “processor instructions” or “computer instructions”) or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although the present invention is illustrated in connection with specific embodiments for instructional purposes, the present invention is not limited thereto. Hence, although item 201 shown in FIGS. 3A and 3D of some embodiments is a mobile device, in other embodiments item 201 is implemented by use of form factors that are different, e.g. in certain other embodiments item 201 is a mobile platform (such as a tablet, e.g. iPad available from Apple, Inc.) while in still other embodiments item 201 is any electronic device or system. Illustrative embodiments of such an electronic device or system 201 may include multiple physical parts that intercommunicate wirelessly, such as a processor and a memory that are portions of a stationary computer, such as a lap-top computer, a desk-top computer, or a server computer 1015 communicating over one or more wireless link(s) with sensors and user input circuitry enclosed in a housing 201 (FIG. 6) that is small enough to be held in a hand.

Accordingly, various techniques of the type described above are used for computer vision and augmented reality applications in some embodiments, to visually guide a user of these applications to move a handheld device in a prescribed movement. This process is used for the initialization and/or for re-calibration of the algorithms, e.g. used in augmented reality software 1014 executed by processor 300 in mobile device 201. The above described visual guidance by device 201 provides directions to an uninitiated user, such that one or more predetermined movements are executed correctly (e.g. in a manner similar or identical to, as prescribed).

As noted above, methods of the type described herein use visual cues displayed on screen 202 of device 201 to lead the user through a prescribed movement. Several examples of such methods are based on a symbol (e.g. a red circle or ball, similar or identical to the above-described dynamic icon T) which is displayed on screen 202 in conjunction with another symbol (e.g. a white circle or hole similar or identical to the above-described reference icon R). The user is instructed via separate directions (e.g. through a speaker in handheld device 201) to continuously move the red circle into the white circle. As noted above, the appearance of the red circle is controlled in such embodiments by a pattern of prescribed movements and based on actual movement identified by measurements from sensors 361 in handheld device 201. For example, if a prescribed movement is to the left, the red ball is shown to the right of the white circle. Sensors 361 supply measurement signals that are used by device 201 to display visual feedback on screen 202 by moving the red ball in the opposite direction of actual movement of device 201.

Depending on how the sensor output is evaluated, a user can be instructed to either move or tilt device 201 or a combination of both. By programming a trajectory of the bias for the red circle, a simple or complex motion can be realized. The circles could be semi-transparent or opaque depending on the embodiment. Additionally haptic feedback (e.g. by vibration of device 201) is provided by triggering haptic feedback circuitry 1018 (FIG. 6) in some embodiments, to provide feedback to the user when the actual movement of device 201 results in a correct alignment of the red and white circle. Instead of the just-described haptic feedback, audio feedback may be provided via a speaker in device 201, in other embodiments.

Various adaptations and modifications may be made without departing from the scope of the invention. For example, touch screen 202 may be replaced by a screen 292 that is not sensitive to touch but displays an icon that is dynamically updated to indicate an instantaneous to-be-performed movement to the user as described above (with or without a reference icon), in some embodiments that calibrate sensors when a user moves device 201 in real world in the prescribed manner, but do not require any touch input from the user via screen 202 (and so any cell phone with a conventional display 292 that is not touch sensitive can implement some embodiments).

Moreover, depending on the embodiment, in addition to an icon S (FIG. 4A), one or more directions to the user related to a prescribed movement may be optionally displayed on screen 202. Hence, some embodiments may display a distance of the prescribed movement in the form of text, e.g. display a string of characters “1 foot” (not shown) on screen 202, in addition to the arrow of icon S shown in FIG. 4A, to further indicate the amount of movement in the real world, which remains to be performed on device 201. In such embodiments, the character string on screen 202 may be updated

Therefore, the spirit and scope of the appended claims should not be limited to the foregoing description. It is to be understood that several other aspects of the invention will become readily apparent to those skilled in the art from the description herein, wherein it is shown and described various aspects by way of illustration.

The drawings and detailed description are to be regarded as illustrative in nature and not as restrictive.

1. A method of visually guiding motion to be performed on a handheld device, the method comprising:
displaying on a screen of the handheld device, at least an icon with an attribute having an initial value;
wherein the initial value is indicative of a predetermined movement to be performed on the handheld device in real world;
at least one processor computing a revised value for the attribute based on an instantaneous to-be-performed movement;
wherein the instantaneous to-be-performed movement depends on the predetermined movement to be performed and at least one measurement of movement of the handheld device in real world;
re-displaying on the screen, at least the icon with the attribute having the revised value; and
repeatedly performing the computing and the re-displaying, with the attribute of the icon changing on the screen based on at least the predetermined movement and additional measurements of movement of the handheld device in the real world.

2. The method of claim 1 wherein:
the computing comprises scaling a difference between a first distance identified in the predetermined movement and a second distance identified in the at least one measurement.

3. The method of claim 1 wherein:
the attribute is a position of the icon.

4. The method of claim 1 wherein:
the attribute is at least one of a length of the icon and a size of the icon.

5. The method of claim 1 further comprising, when performance of the predetermined movement is completed:
repeating the displaying, the computing and the re-displaying with another predetermined movement selected from among a plurality of predetermined movements specified in a sequence in a memory of the handheld device.

6. The method of claim 5 further comprising:
on completion of performance of all predetermined movements identified in the sequence, indicating the completion.

7. The method of claim 6 wherein:
the completion is indicated by vibrating the handheld device.

8. The method of claim 1 wherein the icon is hereinafter a dynamic icon, the method further comprising:
displaying a reference icon on the screen in addition to the dynamic icon;
wherein the reference icon is displayed at a predetermined location on the screen during the displaying of the dynamic icon with the initial value indicative of the predetermined movement; and
wherein the reference icon continues to be displayed at the predetermined location on the screen during the re-displaying of the dynamic icon with the revised value of the attribute.

9. The method of claim 8 wherein:
the predetermined location is a center of the screen.

10. The method of claim 1 wherein:
the at least one measurement is of only translation in the movement of the handheld device in the real world.

11. The method of claim 1 wherein:
the at least one measurement is made by a gyroscope within the handheld device.

12. The method of claim 1 wherein the handheld device comprises a rear-facing camera, the method further comprising:
using the rear-facing camera to obtain a live video of a scene in the real world;
wherein the icon is displayed on the screen superimposed on the live video.

13. The method of claim 1 wherein:
the re-displaying is performed multiple times per second.

14. The method of claim 1 further comprising:
storing the at least one measurement in a memory of the handheld device; and
supplying the at least one measurement as an input to calibration of a camera in the handheld device.

15. A handheld device for visually guiding motion to be performed by a user, the handheld device comprising:
a memory storing a plurality of coordinates indicative of a sequence of predetermined movements to be performed on the handheld device for calibration, the memory further storing a plurality of computer instructions;
a screen coupled to the memory to display therefrom an icon with an attribute;
a sensor to sense movement of the handheld device in real world;
a processor coupled to the memory to execute a group of first instructions among the plurality of computer instructions in the memory, to supply to the screen via the memory, an initial image comprising the icon with an initial value of the attribute, based on a predetermined movement selected from among the sequence in the memory;
the processor being programmed to execute a group of second instructions among the plurality of computer instructions in the memory, to supply to the screen via the memory, a revised image comprising the icon with a revised value of the attribute, the revised value being computed based on an instantaneous to-be-performed movement, wherein the instantaneous to-be-performed movement is computed based at least on the predetermined movement and a measurement by the sensor of the movement of the handheld device in the real world;
wherein the processor is further programmed to repeatedly execute the group of second instructions, to change the attribute of the icon on the screen based on at least the predetermined movement and additional measurements by the sensor of additional movements of the handheld device in real world.

16. The handheld device of claim 15 wherein:
the processor is further programmed to repeat execution of the group of second instructions multiple times a second, thereby displaying a sequence of frames on the screen.

17. The handheld device of claim 15 wherein:
the attribute is a position of the icon.

18. The handheld device of claim 15 wherein:
the attribute is at least one of a length of the icon and a size of the icon.

19. The handheld device of claim 15 wherein:
the icon is hereinafter a dynamic icon; and
the processor is further programmed with additional computer instructions to include in each of the initial image and the revised image, a reference icon in addition to the dynamic icon.

20. The handheld device of claim 19 wherein:
the reference icon is located at a center of the initial image; and
the reference icon is located at the center of the revised image.

21. The handheld device of claim 15 wherein:
the sensor is a gyroscope.

22. The handheld device of claim 15 wherein:
each measurement includes translation and excludes tilt.

23. The handheld device of claim 15 wherein:
the screen is located on a front side of the handheld device and a camera is located on a rear side of the handheld device, the front side being opposite to the rear side;
the memory comprises the icon superimposed on a frame of a live video of a real world scene sensed by the camera; and
the screen displays the icon superimposed on the frame of the live video.

24. One or more storage media comprising computer instructions, which, when executed in a handheld device, cause one or more processors in the handheld device to perform operations, the computer instructions comprising:
instructions to display on a screen of the handheld device, an icon with an attribute having an initial value, the initial value being indicative of a predetermined movement, the predetermined movement being selected from among a plurality of predetermined movements to be performed on the handheld device for calibration of the handheld device;
instructions to the one or more processors in the handheld device, to compute a revised value for the attribute based on the predetermined movement and at least one measurement of movement of the handheld device in the real world subsequent to execution of the instructions to display;
instructions to re-display on the screen, the icon with the attribute having the revised value; and
instructions to repeatedly invoke execution of the instructions to compute and the instructions to re-display to change the attribute of the icon on the screen based on at least the predetermined movement and additional measurements of the movement of the handheld device in the real world.

25. The one or more storage media of claim 24 wherein:
the instructions to repeatedly invoke are configured to be executed multiple times per second, to generate a sequence of frames in a video.

26. The one or more storage media of claim 24 wherein:
the attribute is a position of the icon on the screen.

27. The one or more storage media of claim 24 wherein:
the attribute is at least one of a length of the icon and a size of the icon.

28. The one or more storage media of claim 24 wherein:
the icon is hereinafter a dynamic icon; and
the one or more storage media further comprise instructions to generate a reference icon in addition to the dynamic icon.

29. The one or more storage media of claim 28 wherein:
the reference icon is to be located at a center of an initial image to be generated on execution of the instructions to display; and
the reference icon is to be located at the center of a revised image to be generated on execution of the instructions to re-display.

30. An apparatus for visually guiding motion to be performed, the apparatus comprising:
means for displaying on a screen of the apparatus, an icon with an attribute having an initial value, the initial value being indicative of a predetermined movement to be performed on the apparatus in real world, for calibration of a camera in the apparatus;
means for computing a revised value for the attribute based on an instantaneous to-be-performed movement, wherein the instantaneous to-be-performed movement depends at least on the predetermined movement to be performed and a measurement by a sensor in the apparatus of an actual movement of the apparatus in real world;
means for re-displaying on the screen, the icon with the attribute having the revised value; and
means for repeatedly triggering operation of the means for computing and the means for re-displaying, with the attribute of the icon changing on the screen based on at least the predetermined movement and additional measurements by the sensor of additional actual movements of the apparatus in the real world.

31. The apparatus of claim 30 wherein the icon is hereinafter a dynamic icon, wherein:
the means for displaying displays a reference icon on the screen at a fixed location simultaneous with display of the dynamic icon with the initial value of the attribute and simultaneous with re-display of the dynamic icon with the revised value of the attribute.

32. The apparatus of claim 30 wherein:
the icon is displayed on the screen superimposed on a live video of a real world scene sensed by a camera in the apparatus.

33. The apparatus of claim 30 wherein:
each measurement is of only translation in the actual movement of the apparatus in real world.
